(19) United States
(12) Patent Application Publication
(10) Pub. No.: US 2009/0192708 A1
(43) Pub. Date: Jul. 30, 2009

(54) Method and system for estimating step length pedestrian navigation system

(75) Inventors: Ho-Joon Yoo, Seoul (KR); Chan-Gook Park, Seoul (KR); Sang-On Choi, Suwon-si (KR); Hee-Seob Ryu, Suwon-si (KR); Hyun-Wook Kim, Gyeongsangnam-do (KR); Seung-Hyuck Shin, Ulsan (KR)

Correspondence Address: STAAS & HALSEY LLP, SUITE 700, 1201 NEW YORK AVENUE, N.W., WASHINGTON, DC, 20005, US

(73) Assignees: SAMSUNG ELECTRONICS CO., LTD., Suwon-si (KR); SEOUL NATIONAL UNIVERSITY INDUSTRY FOUNDATION, Seoul (KR)

(21) Appl. No.: 12/314,336

(22) Filed: Dec. 8, 2008

(30) Foreign Application Priority Data
Jan. 28, 2008 (KR) 10-2008-0008632

(51) Int. Cl. G01C 21/10

(52) U.S. Cl. 701/213

(57) ABSTRACT

A method and system for estimating a step length in a pedestrian navigation system is provided. The method of estimating a step length in a pedestrian navigation system includes calculating a walking frequency and an acceleration variance of a pedestrian by using acceleration data acquired from an acceleration sensor, calculating a walking distance of the pedestrian by using GPS data acquired from a GPS receiver, and estimating a step length of the pedestrian by using the calculated walking frequency, acceleration variance, and walking distance.

### CROSS-REFERENCE TO RELATED APPLICATION

This application is based on and claims priority from Korean Patent Application No. 10-2008-0008632, filed on Jan. 28, 2008, in the Korean Intellectual Property Office, the disclosure of which is incorporated herein in its entirety by reference.

### BACKGROUND OF THE INVENTION

1. Field of the invention

The present invention relates to a method and system for estimating a step length in a pedestrian navigation system, and more particularly to a method and system capable of estimating a step length of a pedestrian in real time by introducing a global positioning system (GPS) in a pedestrian navigation system.

2. Description of the Prior Art

A pedestrian navigation system is a system that provides user's accurate location information by using various positioning technologies in order to provide various location based service (LBS) including path finding to a pedestrian.

The pedestrian navigation system, unlike a car navigation system that entirely depends on a GPS system, requires various kinds of sensor information in addition to the GPS in order to provide accurate location information in a GPS shaded area such as a downtown area, indoor place/underground, and the like.

A navigation system using a general sensor may be an inertial navigation system. According to the inertial navigation system, a distance is calculated by twice integration of acceleration and angular acceleration by using an acceleration sensor and a gyro sensor, and thus an accumulated error may increase with the lapse of time.

On the other hand, in the pedestrian navigation system, a moving distance and location of a pedestrian can be estimated by using the number of steps and the step length of the pedestrian. In estimating the moving distance and the location of the pedestrian, the step length may differ for each pedestrian, and even the same pedestrian may have different step lengths depending on the gait of the pedestrian.

Accordingly, there is a need for a method and apparatus capable of estimating the step length of a pedestrian as updating the step length in real time in a pedestrian navigation system.

### SUMMARY OF THE INVENTION

Accordingly, the present invention has been made to solve the above-mentioned problems occurring in the prior art, and an object of the present invention is to provide a method and system capable of estimating a step length of a pedestrian in real time.

Another object of the present invention is to estimate a step length of a pedestrian in real time by estimating a moving distance of the pedestrian in real time by using a GPS receiver.

Still another object of the present invention is to provide a method and system capable of estimating a step length according to a gait of a pedestrian in a state that variable step lengths according to respective pedestrians or gaits of the pedestrian are not pre-learned.

Additional advantages, objects and features of the invention will be set forth in part in the description which follows and in part will become apparent to those having ordinary skill in the art upon examination of the following or may be learned from practice of the invention.

In order to accomplish these objects, there is provided a method of estimating a step length in a pedestrian navigation system, according to the present invention, which includes calculating a walking frequency and an acceleration variance of a pedestrian by using acceleration data acquired from an acceleration sensor; calculating a walking distance of the pedestrian by using GPS data acquired from a GPS receiver; and estimating a step length of the pedestrian by using the calculated walking frequency, acceleration variance, and walking distance.

In another aspect of the present invention, there is provided a method of estimating a step length in a pedestrian navigation system, which includes calculating a walking frequency and an acceleration variance of a pedestrian by using acceleration data acquired from an acceleration sensor; calculating a walking distance of the pedestrian by using GPS data acquired from a GPS receiver; generating a walking frequency matrix and an acceleration variance matrix by using the calculated walking frequency and acceleration variance; calculating a step length estimation coefficient of the pedestrian by using the walking frequency matrix, the acceleration variance matrix, and the walking distance; and estimating a step length of the pedestrian by using the calculated step length estimation coefficient.

In still another aspect of the present invention, there is provided a system for estimating a step length in a pedestrian navigation system, which includes an acceleration data processing unit calculating a walking frequency and an acceleration variance of a pedestrian by using acceleration data acquired from an acceleration sensor; a moving distance calculation unit calculating a walking distance of the pedestrian by using GPS data acquired from a GPS receiver; and a step length estimation unit estimating a step length of the pedestrian by using the calculated walking frequency, acceleration variance, and walking distance.

### BRIEF DESCRIPTION OF THE DRAWINGS

The above and other objects, features and advantages of the present invention will be more apparent from the following detailed description taken in conjunction with the accompanying drawings, in which:

FIG. 1A is a view showing the relation between a general step length and a walking frequency;

FIG. 1B is a view showing the relation between a general step length and a variance of an output of an accelerator;

FIG. 2 is a flowchart illustrating a method of estimating a step length in a pedestrian navigation system according to an embodiment of the present invention;

FIG. 3 is a view showing the relation between a moving distance of a pedestrian acquired by a GPS receiver and a step length of the pedestrian in a method of estimating a step length of the pedestrian in a pedestrian navigation system according to an embodiment of the present invention;

FIG. 4 is a view explaining the inconsistency of sampling times between a GPS receiver and an acceleration sensor of a pedestrian navigation system in a method of estimating a step length of the pedestrian in a pedestrian navigation system according to an embodiment of the present invention; and

FIG. 5 is a block diagram illustrating the configuration of a system for estimating a step length in a pedestrian navigation system.

### DETAILED DESCRIPTION OF THE PREFERRED EMBODIMENTS

Hereinafter, preferred embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

The present invention will be described herein with reference to the accompanying drawings illustrating block diagrams and flowcharts for explaining a method and system for estimating a step length in a pedestrian navigation system according to embodiments of the present invention. It will be understood that each block of the flowchart illustrations, and combinations of blocks in the flowchart illustrations, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions specified in the flowchart block or blocks.

These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

In the embodiments of the present invention, the term “unit”, as used herein, may be implemented as a kind of module. Here, the term “module” means, but is not limited to, a software or hardware component, such as a Field Programmable Gate Array (FPGA) or Application Specific Integrated Circuit (ASIC), which performs certain tasks. A module may advantageously be configured to reside on the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

Hereinafter, embodiments of the present invention will be described in detail with reference to the attached drawings.

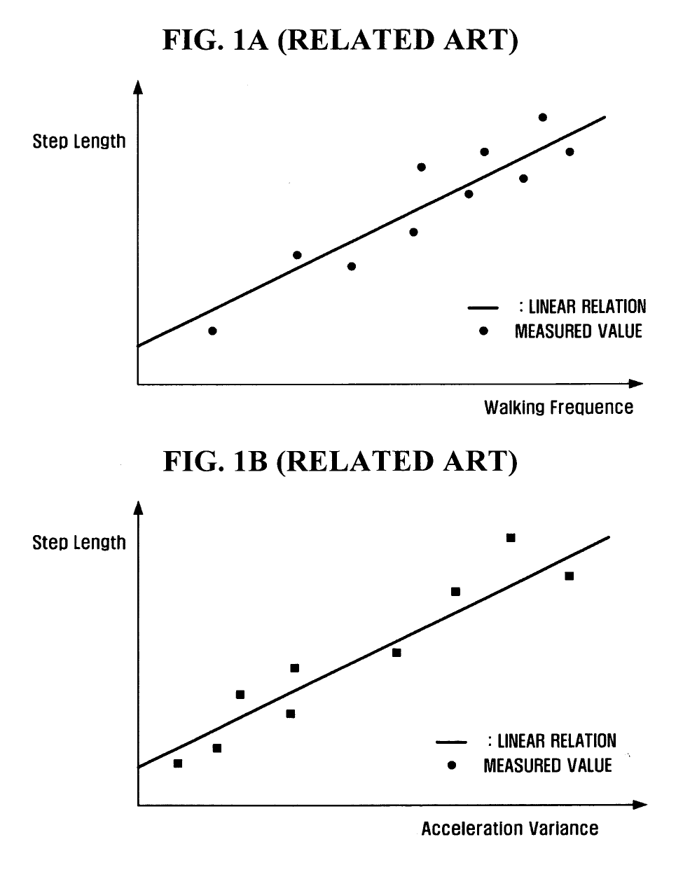

FIG. 1A is a view showing the relation between a general step length and a walking frequency, and FIG. 1B is a view showing the relation between a general step length and a variance of an output of an accelerator.

Referring to FIG. 1A, a walking frequency and a step length generally show a linear relation between them. This means that as the walking frequency becomes higher, the step length of a pedestrian increases, as shown in Equation (1).

S_{WF}(i)=a·WF(i)+b+v_{WF}(i)

σ_{WF}²=E [symbol] v_{WF}²(i) [symbol] (1)

Here, S_{WF}(i) is step length data of the i-th pedestrian estimated on the basis of an acceleration variance, a and b are coefficients of a first order linear equation by the linear estimation, and v_{WF}(i) is a noise of pedestrian step length data in the i-th step index. Also, WF(i) is a walking frequency for the pedestrian step length in the i-th step index, and σ_{WF}(i) is a noise variance for the walking frequency.

Referring to FIG. 1B, an output of an accelerator and the step length generally show a linear relation between them. This physically means that as the acceleration variance increases, the step length of the pedestrian also increases, as shown in Equation (2).

s_{AV}(i)=c·AV(i)+d+v_{AV}(i)

σ_{AV}²=E [symbol] v_{AV}²(i) [symbol] (2)

Here, S_{AV}(i) is step length data of the i-th pedestrian estimated on the basis of an acceleration variance, c and d are coefficients of a first order linear equation by the linear estimation, and v_{AV}(i) is a noise of pedestrian step length data in the i-th step index. Also, AV(i) is an acceleration variance for the pedestrian step length in the i-th step index, and σ_{WF}(i) is a noise variance for the acceleration variance. On the other hand, in an embodiment of the present invention, a, b, c, and d in Equation (1) and Equation (2) are called step length estimation coefficients.

As shown in Equation (1) and Equation (2), the pedestrian step length can be estimated by using the walking frequency (WF) and the acceleration variance (AV), respectively.

On the other hand, the step length S_{P} can be modeled as a linear relation between the step length S_{WF}(i) estimated by using the walking frequency and the step length S_{AV}(i) estimated by using the acceleration variance as represented by Equation (3).

$${s}_{P} ( i ) = {k}_{1} \cdot {s}_{WF} ( i ) + {k}_{2} \cdot {s}_{AV} ( i ) \\ {k}_{1} = \frac{{σ}_{AV}^{2}}{{σ}_{WF}^{2} + {σ}_{AV}^{2}} , {k}_{2} = \frac{{σ}_{WF}^{2}}{{σ}_{WF}^{2} + {σ}_{AV}^{2}} \qquad ( 3 )$$

Here, k₁ and k₂ are proportional coefficients of the step length S_{WF}(i) estimated by using the walking frequency and the step length S_{AV}(i) estimated by using the acceleration variance, respectively, and the sum of k₁ and k₂ becomes 1. k₁ and k₂ are numbers indicating the ratios of dispersion sizes calculated in Equation (1) and Equation (2), respectively, and as the size of the corresponding dispersion becomes smaller, the proportional coefficient increases.

By substituting Equation (1) and Equation (2) into Equation (3), Equation (4) that is a step length estimation equation using the walking frequency and the acceleration variance can be derived.

$$\begin{matrix}{s}_{P} ( i ) = \frac{a \cdot {σ}_{AV}^{2}}{{σ}_{WF}^{2} + {σ}_{AV}^{2}} \cdot WF ( i ) + \frac{c \cdot {σ}_{WF}^{2}}{{σ}_{WF}^{2} + {σ}_{AV}^{2}} \cdot AV ( i ) + \\ \frac{b \cdot {σ}_{AV}^{2} + d \cdot {σ}_{WF}^{2}}{{σ}_{WF}^{2} + {σ}_{AV}^{2}} \\ = α \cdot WF ( i ) + β \cdot AV ( i ) + γ\end{matrix} \qquad ( 4 )$$

As described above, the step length can be estimated by obtaining the walking frequency (WF), the acceleration variance, and the step length estimation coefficients a, b, c, and d, and then multiplying the obtained values by the proportional coefficients k₁ and k₂. If n steps are detected by using the step length model of Equation (4), the moving distance L of the pedestrian is estimated as represented by Equation (5).

$$L = {\sum }_{i = 1}^{n} {s}_{P} ( i ) \qquad ( 5 )$$

Using the step length estimation coefficients a, b, c, and d, or values of α, β, and γ in Equation (4), the step length at the i-th step is calculated, and the total moving distance of the pedestrian is obtained through Equation (5). On the other hand, the calculation of the step length estimation coefficients a, b, c, and d is called “step length estimation parameter learning”, and the step length estimation coefficients a, b, c, and d may have different values in accordance with respective pedestrians. Also, the step length estimation coefficients a, b, c, and d may have different values in accordance with working conditions of the respective pedestrians, such as, a slow pace, an intermediate pace, and a quick pace.

In order to obtain the moving distance of a pedestrian as represented by Equation (5), it is required to know in advance the step length estimation coefficients a, b, c, and d as expressed in Equation (4). Various data sets of the step length estimation coefficients a, b, c, and d are acquired as the walking speed is changed in a predefined straight path. An average walking frequency and an average acceleration variance for each data set are calculated from the data sets acquired in advance, and the walking distance L is divided by the number of steps to obtain an average step length.

According to the above-described method, however, the reliable step length estimation coefficients a, b, c, and d can be obtained only by acquiring the repeated data sets in a state that the moving distance L of the pedestrian is already known. In other words, the data sets should be secured by repeated walking over a straight path in which a moving distance L for each pedestrian is predetermined.

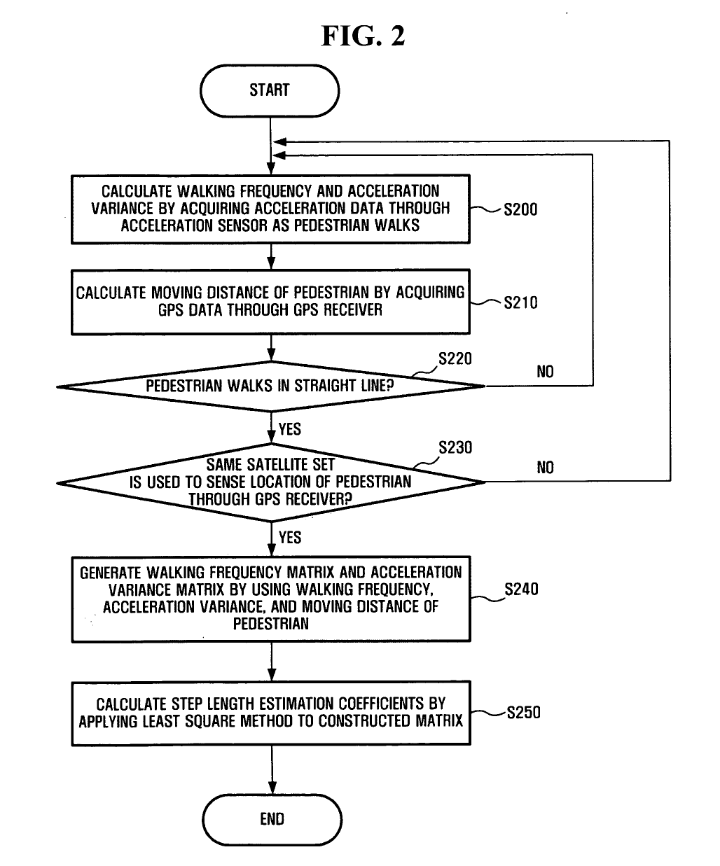

FIG. 2 is a flowchart illustrating a method of estimating a step length in a pedestrian navigation system according to an embodiment of the present invention.

Referring to FIG. 2, as a pedestrian who carries an acceleration sensor is walking, acceleration data is acquired by the acceleration sensor, and a walking frequency and an acceleration variance are calculated in accordance with the pedestrian's walking S200. Here, the acceleration data is an output value of acceleration obtained from the acceleration sensor. Using the acceleration data acquired in real time, the walking frequency and the acceleration variance of the pedestrian are calculated.

The walking frequency is acquired by counting the number of steps using the acceleration data. Examples of step detection methods using the acceleration data include a peak detection method of detecting a peak value of an acceleration sensor output as one step, a flat zone detection method of defining a moment where the change rate of the acceleration sensor output instantaneously approaches 0 as one step, a zero crossing method of recognizing a moment where the acceleration sensor output passes 0 as one step, and the like. Also, in order to remove a signal generated due to a noise of the actual acceleration sensor in detecting the steps, the acceleration sensor output signal can be smoothly processed by using a signal processing technique called sliding window summing.

The acceleration variance is calculated from the acceleration data. The acceleration variance is obtained by calculating the sum of squares of deviations from the average acceleration value. Accordingly, as the acceleration variance becomes larger, the deviation from the average acceleration value becomes larger, and this means that a pedestrian is at a quick pace.

The moving distance of a walking pedestrian is calculated by acquiring global positioning system (GPS) data through a GPS receiver carried by the pedestrian S210. Since the location information of the pedestrian is obtained in real time through a real time acquisition of the GPS data through the GPS receiver, the moving distance of the pedestrian can be calculated accordingly. Alternatively, the moving distance of the pedestrian can be calculated by judging a start point and an end point of detection of the pedestrian's steps and using the GPS data at the start point and the end point.

Meanwhile, it is judged whether the pedestrian walks in straight line S220. If the pedestrian does not walk in straight line, the acquired acceleration data and GPS data are acquired again. The direction change of the pedestrian's walking is sensed by an earth magnetism sensor, a direction sensor, or the like. If the direction of the pedestrian's walking is within a specified threshold range that is recognized as the same direction range as the walking direction based on the received GPS data, it is judged that the pedestrian walks in straight line.

In addition, it is judged whether the same satellite set is used to sense the location of the pedestrian by using the GPS receiver S230. The GPS receiver receives a NMEA (Nation Marine Electronics Association) message. That is, using an NMEA GPGSA message having satellite set information that is used to sense the current location, it is judged whether the satellite set used to sense the moving distance of the pedestrian is changed. This is because the moving distance is obtained by subtracting a value of one place from a value of another place through the GPS receiver foe sensing the moving distance of the pedestrian, and thus if the satellite set from which the GPS receiver receives data is changed during the movement of the pedestrian, an error may occur in estimating the location of the pedestrian.

Generally, an error included in a position measured through the GPS may be caused by a satellite time error, a receiver time error, a satellite orbit error, an ionosphere error, and the like. If the same satellite is used to calculate the location estimation, such a common error element can be removed through the location data difference. Accordingly, in an embodiment of the present invention, an accurate moving distance can be measured through the location data difference during a period where the GPS satellite set is not changed, and if it is judged through the NMEA GPGSA message that the same satellite set is used for the location estimation, the walking frequency, the acceleration variance, and the moving distance Lₖ of the pedestrian can be calculated by using the acceleration data and the GPS data.

If it is judged through the GPS receiver that the satellite set for acquiring the location information of the pedestrian is changed while the pedestrian keeps on walking, the acceleration data and the GPS data are acquired again.

As the pedestrian keeps on walking, the walking frequency, the acceleration variance, and the moving distance of the pedestrian are obtained by using the acceleration data collected by the acceleration sensor and the GPS data acquired by the GPS receiver. Then, a walking frequency matrix and an acceleration variance matrix are obtained from the obtained walking frequency, the acceleration variance, and the moving distance of the pedestrian S240. The walking frequency matrix includes an average walking frequency element for a specified data set, and the acceleration variance matrix includes an average acceleration variance element for a specified data set. Calculation of the walking frequency matrix and the acceleration variance matrix will be described later.

If the walking frequency matrix and the acceleration variance matrix are calculated, the step length estimation coefficients a, b, c, and d are calculated by using the calculated walking frequency matrix and acceleration variance matrix S250. If the step length estimation coefficients a, b, c, and d are calculated, the step length of the pedestrian is estimated by using Equation (4). Accordingly, if the step length estimation coefficients are calculated, the step length of the pedestrian can be estimated in real time.

As described above, according to an embodiment of the present invention, the step length estimation coefficients a, b, c, and d, which may differ for the respective pedestrians, can be calculated in real time, and the step lengths of the respective pedestrians can be estimated by using the calculated step length estimation coefficients. Also, the step lengths of the respective pedestrians, which may differ under the influence of ground conditions, shoes, weather, or the like, can be easily estimated. In addition, the step lengths of the respective pedestrians can be estimated in real time through the walking of the pedestrians, without several times repetition of experiments in a predetermined section.

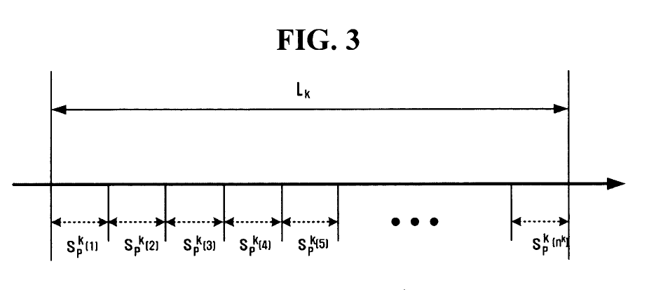

FIG. 3 is a view showing the relation between the moving distance of a pedestrian acquired by a GPS receiver and the step length of the pedestrian in the method of estimating a step length of the pedestrian in a pedestrian navigation system according to an embodiment of the present invention.

Referring to FIG. 3, it is assumed that the pedestrian takes the i-th step S_{P}^{k}(i) to walk on the road or street. At the step s_{P}^{k}(i), S_{P} denotes the step length of the pedestrian, and k denotes the k-th data set.

A plurality of data sets are acquired as the pedestrian keeps on walking. For example, in the case of acquiring the k-th data set, the distance Lₖ, for which the pedestrian moves while the k-th data set is acquired, can be detected by using the GPS receiver. In addition, the steps of the pedestrian can be detected by using an output value of the acceleration sensor carried by the pedestrian.

The pedestrian detects the steps by using the acceleration data from the acceleration sensor. If the steps are detected, the walking frequency (WF), which is the number of steps per unit time, can be calculated, and the acceleration variance (AV) can be calculated by using the output value of the acceleration sensor.

The calculation of the step length estimation coefficients a, b, c, and d from a plurality of data sets acquired through the pedestrian's walking follows a process expressed in Equation (6).

$${\overline{s}}_{P}^{k} = \frac{{L}_{k}}{{n}^{k}} = E 〈 {s}_{WF}^{k} 〉 = a \cdot E 〈 {WF}^{k} 〉 + b = a \cdot {\overline{WF}}^{k} + b \\ {\overline{s}}_{P}^{k} = \frac{{L}_{k}}{{n}^{k}} = E 〈 {s}_{AV}^{k} 〉 = a \cdot E 〈 {AV}^{k} 〉 + b = a \cdot {\overline{AV}}^{k} + b \qquad ( 6 )$$

Here, nₖ denotes the number of steps of a pedestrian in the k-th data set, and Lₖ denotes a moving distance of a pedestrian while the k-th data set is acquired.

Equation (6) as described above is expressed in the form of a matrix as represented by Equation (7).

$${\overline{s}}_{P}^{WF} = [ \begin{matrix}{\overline{s}}_{P}^{1} \\ {\overline{s}}_{P}^{2} \\ ⋮ \\ {\overline{s}}_{P}^{N}\end{matrix} ] = [ \begin{matrix}{\overline{WF}}^{1} & 1 \\ {\overline{WF}}^{2} & 1 \\ ⋮ & ⋮ \\ {\overline{WF}}^{N} & 1\end{matrix} ] [ \begin{matrix}a \\ b\end{matrix} ] ≡ {H}_{WF} \cdot {x}_{WF} \\ {\overline{s}}_{P}^{AV} = [ \begin{matrix}{\overline{s}}_{P}^{1} \\ {\overline{s}}_{P}^{2} \\ ⋮ \\ {\overline{s}}_{P}^{N}\end{matrix} ] = [ \begin{matrix}{\overline{AV}}^{1} & 1 \\ {\overline{AV}}^{2} & 1 \\ ⋮ & ⋮ \\ {\overline{AV}}^{N} & 1\end{matrix} ] [ \begin{matrix}a \\ b\end{matrix} ] ≡ {H}_{AV} \cdot {x}_{AV} \qquad ( 7 )$$

Here, H_{WF} denotes a walking frequency matrix, and H_{AV} denote an acceleration variance matrix. Since the distance Lₖ for which the pedestrian moves can be known by using the GPS data acquired by the GPS receiver, an average step length S_{P}^{-k} for each data set can be obtained. Accordingly, the step length estimation coefficients a, b, c, and d can be obtained by using the least square method as represented by Equation (8).

$$[ \begin{matrix}a \\ b\end{matrix} ] = {x}_{WF} = {[ {H}_{WF}^{T} {H}_{WF} ]}^{- 1} {H}_{WF}^{T} \cdot {\overline{s}}_{P}^{WF} \\ [ \begin{matrix}c \\ d\end{matrix} ] = {x}_{AV} = {[ {H}_{AV}^{T} {H}_{AV} ]}^{- 1} {H}_{AV}^{T} \cdot {\overline{s}}_{P}^{AV} \qquad ( 8 )$$

As described above, the step length estimation coefficients of the pedestrian are estimated by using the distance, for which the pedestrian walks, calculated through the GPS receiver, and the walking frequency and the acceleration variance calculated by the output value of the acceleration sensor. Then, the step length of the pedestrian is obtained by using the estimated step length estimation coefficients as a function of the walking frequency and acceleration variance. Accordingly, the step length of the pedestrian can be estimated in real time by acquiring data as the pedestrian walks, without the necessity of several times repetition of experiments in a predetermined distance.

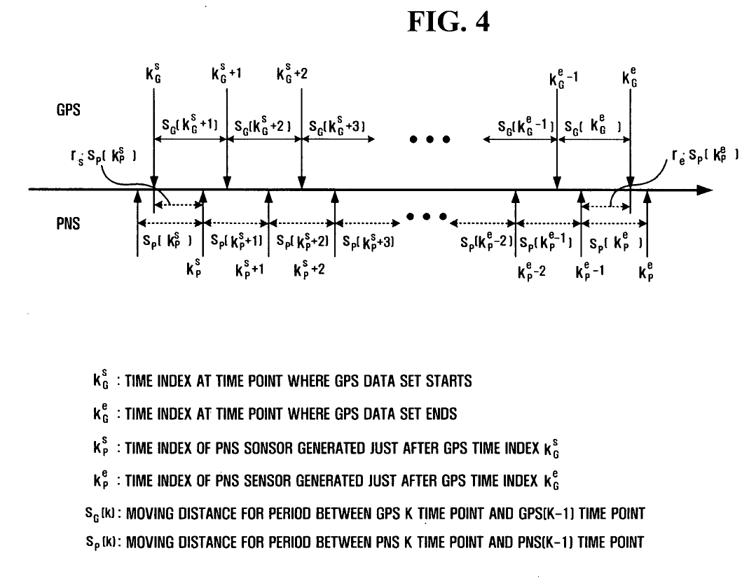

FIG. 4 is a view explaining the inconsistency of sampling times between the GPS receiver and the acceleration sensor of the pedestrian navigation system in the method of estimating a step length of the pedestrian in the pedestrian navigation system according to an embodiment of the present invention.

Generally, there is a difference between the sampling frequency of a GPS signal and the sampling frequency of an acceleration sensor. Accordingly, if the distance, which corresponds to the number of steps obtained by the acceleration sensor, is calculated by using the GPS signal sensed by the GPS receiver, an error may occur in the calculated distance due to the inconsistency in sampling period. Accordingly, it is required to calculate the moving distance of the pedestrian in consideration of the difference between the sampling frequency of the GPS signal and the walking frequency.

Referring to FIG. 4, in order to obtain the moving distance by using the GPS data acquired by the GPS receiver for a specified period, it is required to estimate the difference in distance between k_{G}^{s}˜k_{P}^{s} and the difference in distance between k_{G}^{e}˜(k_{P}^{e}−1). If it is assumed that the distances are rₛ·s_{P}(k_{P}^{s}) and rₑ·s_{P}(k^{P}^{e}), respectively, Equation (9) can be expanded under the assumption that the walking speed of the pedestrian is constant for one step.

$${d}_{G} = {\sum }_{i = {k}_{G}^{s} + 1}^{{k}_{G}^{e}} {s}_{G} ( i ) \\ {d}_{P} = {r}_{s} \cdot {s}_{P} ( {k}_{P}^{s} ) + {\sum }_{i = {k}_{P}^{s} + 1}^{{k}_{P}^{e} - 1} {s}_{P} ( i ) + {r}_{e} \cdot {s}_{P} ( {k}_{P}^{e} ) \qquad ( 9 )$$

Here, k_{G}^{s} is a time index at a time point where a GPS data set starts, k_{G}^{e} is a time index at a time point where the GPS data set ends, k_{P}^{s} is a time index of a pedestrian navigation system (PNS) sensor generated just after the GPS time index k_{G}^{s}, and k_{P}^{e} is a time index of a PNS sensor generated just after the GPS time index k_{G}^{e}. s_{G}(k) is a moving distance for a period between a GPS k time point and a GPS (k−1) time point, and s_{P}(k) is a moving distance for a period between a PNS k time point and a PNS (k−1) time point. On the other hand, rₛ and rₑ are coefficients for estimating the difference in distance between k_{G}^{s}˜k_{P}^{s} and the difference in distance between k_{G}^{e}˜(k_{P}^{e}˜1), respectively.

Here, rₛ and rₑ can be calculated by Equation (10).

$${r}_{s} = \frac{{k}_{P}^{s} \cdot {T}_{P} - {k}_{G}^{s} \cdot {T}_{G}}{{T}_{P}} \\ {r}_{e} = \frac{{k}_{G}^{e} \cdot {T}_{G} - ( {k}_{G}^{e} - 1 ) \cdot {T}_{P}}{{T}_{P}} \qquad ( 10 )$$

Here, T_{G} and T_{P} are sampling periods of the GPS receiver and the PNS sensor. In principle, Equation (11) is expanded by substituting Equation (9) into Equation (1) by using the relation in that the moving distance of the pedestrian calculated by the GPS receiver is always equal to the moving distance of the pedestrian calculated by the pedestrian navigation system.

$$\begin{matrix}{d}_{G} = {\sum }_{i = {k}_{G}^{s} + 1}^{{k}_{G}^{e}} {s}_{G} ( i ) = {d}_{P} \\ = {r}_{s} \cdot {s}_{WF} ( {k}_{P}^{s} ) + {\sum }_{i = {k}_{P}^{s} + 1}^{{k}_{P}^{e} - 1} {s}_{WF} ( i ) + {r}_{e} \cdot {s}_{WF} ( {k}_{P}^{e} ) \\ = a \cdot [ {r}_{s} \cdot WF ( {k}_{P}^{s} ) + {\sum }_{i = {k}_{p}^{s} + 1}^{{k}_{P}^{e} - 1} WF ( i ) + {r}_{e} \cdot WF ( {k}_{P}^{e} ) ] + \\ b \cdot [ {r}_{s} + ( {k}_{P}^{e} - {k}_{P}^{s} - 1 ) + {r}_{e} ]\end{matrix} \qquad ( 11 )$$

An average walking frequency for one step is obtained in Equation (11) and expressed in a walking frequency matrix as represented by Equation (12).

$$\begin{matrix}{\overline{s}}_{G} = \frac{1}{{r}_{s} + ( {k}_{P}^{e} - {k}_{P}^{s} - 1 ) + {r}_{e}} {\sum }_{i = {k}_{G}^{s} + 1}^{{k}_{G}^{e}} {s}_{G} ( i ) \\ = [ \frac{{r}_{s} \cdot WF ( {k}_{p}^{s} ) + {\sum }_{i = {k}_{P}^{s} + 1}^{{k}_{P}^{e} - 1} WF ( i ) + {r}_{e} \cdot WF ( {k}_{P}^{e} )}{{r}_{s} + ( {k}_{P}^{e} - {k}_{P}^{s} - 1 ) + {r}_{e}} 1 ] [ \begin{matrix}a \\ b\end{matrix} ] \\ ≡ [ {\overline{WF}}_{Θ} 1 ] [ \begin{matrix}a \\ b\end{matrix} ]\end{matrix} \qquad ( 12 )$$

The walking frequency matrix for n data sets can be expressed in Equation (13).

$${\overline{s}}_{G}^{WF} = [ \begin{matrix}{\overline{s}}_{G}^{1} \\ {\overline{s}}_{G}^{2} \\ ⋮ \\ {\overline{s}}_{G}^{N}\end{matrix} ] = [ \begin{matrix}{\overline{WF}}_{Θ}^{1} & 1 \\ {\overline{WF}}_{Θ}^{2} & 1 \\ ⋮ & ⋮ \\ {\overline{WF}}_{Θ}^{n} & 1\end{matrix} ] [ \begin{matrix}a \\ b\end{matrix} ] ≡ {Θ}_{WF} \cdot {x}_{WF} \qquad ( 13 )$$

Accordingly, the step length estimation coefficients a and b can be calculated by using the least square method as represented by Equation (14).

$$[ \begin{matrix}a \\ b\end{matrix} ] = {x}_{WF} = {[ {Θ}_{WF}^{T} {Θ}_{WF} ]}^{- 1} {Θ}_{WF}^{T} \cdot {\overline{s}}_{G}^{WF} \qquad ( 14 )$$

In a similar manner, the step length estimation coefficients c and d can be calculated in Equation (15) by substituting Equation (9) into Equation (2) and applying the least square method to the coefficients by using the relation in that the moving distance of the pedestrian calculated by the GPS receiver is always equal to the moving distance of the pedestrian calculated by the pedestrian navigation system.

$$[ \begin{matrix}c \\ d\end{matrix} ] = {x}_{AV} = {[ {Θ}_{AV}^{T} {Θ}_{AV} ]}^{- 1} {Θ}_{AV}^{T} \cdot {\overline{s}}_{G}^{AV} \qquad ( 15 )$$

Here, the acceleration variance matrix Θ_{V} can be obtained by Equation (16).

$${Θ}_{AV} = [ \begin{matrix}{\overline{AV}}_{Θ}^{1} & 1 \\ {\overline{AV}}_{Θ}^{2} & 1 \\ ⋮ & ⋮ \\ {\overline{AV}}_{Θ}^{n} & 1\end{matrix} ] \qquad ( 16 )$$

Here, A̅V̅_{Θ}^{j} is a value representing an average of the acceleration variance in the j-th data set, and the average of the acceleration variance of the respective data sets can be obtained by Equation (17).

$${\overline{AV}}_{Θ} = \frac{{r}_{s} \cdot WF ( {k}_{P}^{s} ) + {\sum }_{i = {k}_{P}^{s} + 1}^{{k}_{P}^{e} - 1} WF ( i ) + {r}_{e} \cdot WF ( {k}_{P}^{e} )}{{r}_{s} + ( {k}_{P}^{e} - {k}_{P}^{s} - 1 ) + {r}_{e}} \qquad ( 17 )$$

Accordingly, using Equations (14) and (15) expanded in the case where the sampling times between the GPS receiver and the acceleration sensor are inconsistent with each other, the step length estimation coefficients a, b, c, and d can be obtained. Also, the step length of the pedestrian can be estimated by acquiring the moving distance of the pedestrian for a specified section through the GPS receiver and using the number of steps and the acceleration variance obtained through the acceleration sensor for the moving distance, without several times repetition of experiments in a predetermined section.

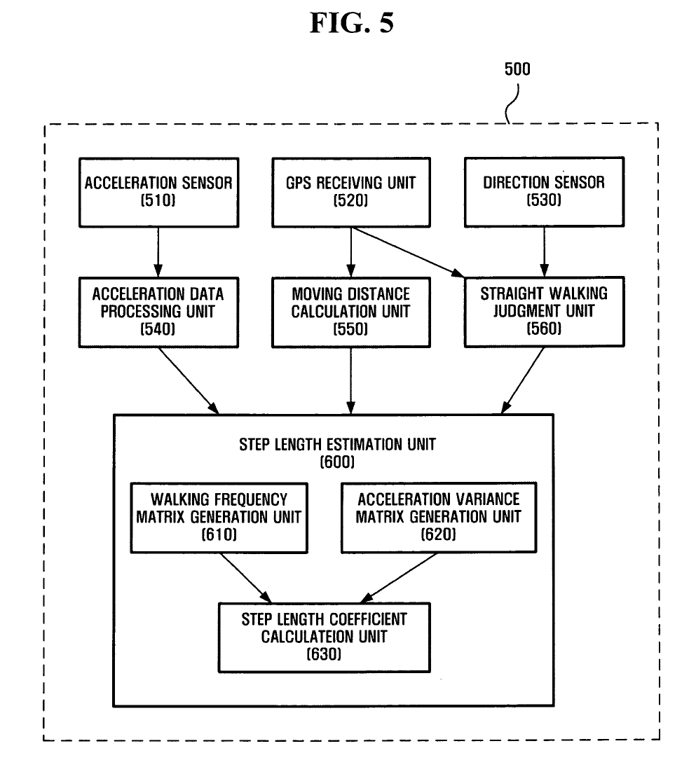

FIG. 5 is a block diagram illustrating the configuration of a system for estimating a step length in a pedestrian navigation system.

Referring to FIG. 5, the system for estimating a step length in a pedestrian navigation system according to an embodiment of the present invention includes an acceleration sensor 510, a GPS receiving unit 520, a direction sensor 530, an acceleration data processing unit 540, a moving distance calculation unit 550, a straight walking judgment unit 560, and a step length estimation unit 600.

The acceleration sensor 510 is carried by a pedestrian, and acquires acceleration data from the pedestrian's steps. The acceleration sensor 510 senses and acquires acceleration data in a direction perpendicular to the walking direction of the pedestrian and acceleration data for three orthogonal axes. For example, the acceleration sensor 510 may be a piezoelectric type accelerometer that transforms mechanical energy into electric energy. Even in the case of applying a shear force in addition to a compression force, the acceleration can be measured through the transformation of the mechanical energy into the electric energy. In addition, various types of acceleration sensors, such as a vibration type, a strain gauge type, an electrodynamic type, a servo type, and the like, may be used to sense the acceleration.

The acceleration data processing unit 540 calculates the walking frequency and the acceleration variance of the pedestrian by using the acceleration data acquired by the acceleration sensor 510. The acceleration data processing unit 540 recognizes the steps of the pedestrian through grasping of the waveform or feature of the acceleration data, and calculates the walking frequency by calculating the number of steps for a specified time. The acceleration data processing unit 540 also calculates the acceleration variance obtained by calculating the sum of squares of deviations from the average acceleration value for each step by using the acceleration data. The acceleration data processing unit 540 can calculate the walking frequency and the acceleration variance by using the acceleration data sensed for a specified distance or for a specified time period, and can calculate n walking frequencies and acceleration variances for n acceleration data sets by repeating the above-described calculation.

The GPS receiving unit 520 receives signals from GPS satellite sets, and estimates the location of the pedestrian. The GPS receiving unit 520 uses an NMEA protocol from a GPS satellite set, and can recognize the satellite set being used to estimate the pedestrian's location with reference to a GPGSA message item in a message according to the NMEA protocol.

The moving distance calculation unit 550 calculates the moving distance of the pedestrian through the estimation of the pedestrian's location performed by the GPS receiving unit 520. The moving distance calculation unit 550 calculates the distance between a start point and an end point of the walking. Also, the moving distance calculation unit 550 judges whether the same satellite set is used to obtain the distance between the start point and the end point by using the GPGSA in the NMEA data. If the same satellite set is used, the distance between the start point and the end point may be accurately estimated, whereas if different satellite sets are used, the accuracy of the distance estimation may be lowered. Accordingly, the moving distance calculation unit 550 calculates the moving distance of the pedestrian based on the location estimation data obtained by using the same satellite set.

The direction sensor 530 senses the walking direction of the pedestrian. In an embodiment of the present invention, the step length is estimated while the pedestrian walks in straight line since the accuracy is relatively heightened in estimating the step length. When the pedestrian walks in a curved line or changes the walking direction, it is not easy for the moving distance calculation unit 550 to accurately calculate the moving distance of the pedestrian.

The direction sensor 530 may be an earth magnetism sensor or a gyro sensor that senses the walking direction of the pedestrian. On the other hand, the walking direction of the pedestrian may also be sensed by the GPS receiving unit 520.

The straight walking judgment unit 560 judges whether the pedestrian walks in straight line. The straight walking judgment unit 560 judges whether the pedestrian walks in straight line in a specified section by using walking direction data of the pedestrian acquired by the direction sensor 530 or the GPS receiving unit 520. If the walking direction of the pedestrian exceeds a threshold value in comparison to the previous walking direction, or if the moving direction of the pedestrian at the present time exceeds a threshold value in comparison to the moving direction of the pedestrian from the time when the data for the step length estimation is acquired to the present, it is judged that the pedestrian does not walk in straight line.

If it is judged that the pedestrian does not walk in straight line, the straight walking judgment unit 560 reports the judgment to the step length estimation system 500 according to an embodiment of the present invention, so that the acceleration sensor 510 and the GPS receiving unit 520 acquire again the acceleration data and the GPS data, respectively.

The step length estimation unit 600 estimates the step length of the pedestrian by using the calculated walking frequency, acceleration variance, and walking distance. The step length estimation unit 600 generates a walking frequency matrix and an acceleration variance matrix by using the walking frequency and the acceleration variance, and calculates step length estimation coefficients by using the walking distance, the walking frequency matrix, and the acceleration variance matrix.

The step length estimation unit 600 includes a walking frequency matrix generation unit 610, an acceleration variance matrix generation unit 620, and a step length estimation coefficient calculation unit 630.

The walking frequency matrix generation unit 610 generates the walking frequency matrix derived from the walking frequency. The walking frequency matrix generation unit 610 generates the walking frequency matrix by using Equation (7) or Equation (13). Also, if a sampling time for acquiring the acceleration data through the acceleration sensor is inconsistent with a sampling time for acquiring the GPS data through the GPS receiver, the walking frequency matrix generation unit 610 generates the walking frequency matrix by using Equation (13) in consideration of the sampling time inconsistency.

The acceleration variance matrix generation unit 620 generates the acceleration variance matrix derived from the acceleration variance. The acceleration variance matrix generation unit 620 generates the acceleration variance matrix by using Equation (7) or Equation (16). Also, if the sampling times of the acquired acceleration data and GPS data are inconsistent with each other, the acceleration variance matrix generation unit 620 generates the acceleration variance matrix by using Equation (16) in consideration of the sampling time inconsistency.

The step length estimation coefficient calculation unit 630 calculates step length estimation coefficients a, b, c, and d by using the generated walking frequency matrix and acceleration variance matrix. The step length estimation coefficients are calculated by using one of Equations (8), (14), and (15) using the least square method.

By substituting the calculated step length estimation coefficients into Equation (4), the step length of the pedestrian can be estimated in real time.

As described above, according to the present invention, the step length of the pedestrian can be estimated in real time without experiments for estimating the step length of the pedestrian in a predetermined section. Also, by obtaining the moving distance of the pedestrian using the GPS receiver 520, the step length can be estimated even in the case where walking patterns, topographies, and/or walking conditions of the respective pedestrians differ.

The preferred embodiments of the present invention have been described for illustrative purposes, and those skilled in the art will appreciate that various modifications, additions and substitutions are possible without departing from the scope and spirit of the invention as disclosed in the accompanying claims. Therefore, the scope of the present invention should be defined by the appended claims and their legal equivalents.

What is claimed is:

1. A method of estimating a step length in a pedestrian navigation system, comprising:
calculating a walking frequency and an acceleration variance of a pedestrian by using acceleration data acquired from an acceleration sensor;
calculating a walking distance of the pedestrian by using GPS data acquired from a GPS receiver; and
estimating a step length of the pedestrian by using the calculated walking frequency, acceleration variance, and walking distance.

2. The method of claim 1, wherein the estimating the step length comprises generating a walking frequency matrix and an acceleration variance matrix by using the calculated walking frequency and acceleration variance; and calculating step length estimation coefficients by using the walking distance, the walking frequency matrix, and the acceleration variance matrix.

3. The method of claim 1, wherein the calculating the walking distance comprises judging whether the pedestrian walks in straight line.

4. The method of claim 1, wherein the calculating the walking distance comprises judging whether the same satellite data set is used to calculate the walking distance by using an NMEA GPGSA message item of the GPS data; and
wherein the NMEA GPGSA message item includes satellite data set information received by the GPS receiver.

5. The method of claim 1, wherein the calculating the walking frequency comprises calculating the walking frequency by any one of a zero crossing method of recognizing a moment where the acceleration data value passes 0 as one step, a peak detection method of detecting a peak value of the acceleration data as one step, and a flat zone detection method of defining a moment where a change rate of the acceleration data instantaneously approaches 0 as one step.

6. The method of claim 1, wherein the estimating comprises calculating step length estimation coefficients of the pedestrian by constructing a walking frequency matrix derived from the walking frequency and an acceleration variance matrix derived from the acceleration variance.

7. The method of claim 6, wherein the estimating comprises generating the walking frequency matrix and the acceleration variance matrix in consideration of inconsistency between a sampling time for acquiring the acceleration data through the acceleration sensor and a sampling time for acquiring the GPS data through the GPS receiver if the sampling times are inconsistent with each other.

8. A method of estimating a step length in a pedestrian navigation system, comprising:
calculating a walking frequency and an acceleration variance of a pedestrian by using acceleration data acquired from an acceleration sensor;
calculating a walking distance of the pedestrian by using GPS data acquired from a GPS receiver;
generating a walking frequency matrix and an acceleration variance matrix by using the calculated walking frequency and acceleration variance;
calculating a step length estimation coefficient of the pedestrian by using the walking frequency matrix, the acceleration variance matrix, and the walking distance; and
estimating a step length of the pedestrian by using the calculated step length estimation coefficient.

9. The method of claim 8, wherein the generating comprises:
acquiring a plurality of walking frequencies and acceleration variances;
constructing the walking frequency matrix having an average walking frequency as its element; and
constructing the acceleration variance matrix having an average acceleration variance as its element.

10. The method of claim 8, wherein the generating the walking frequency matrix comprises generating the walking frequency matrix and the acceleration variance matrix in consideration of inconsistency between a sampling time for acquiring the acceleration data through the acceleration sensor and a sampling time for acquiring the GPS data through the GPS receiver if the sampling times are inconsistent with each other.

11. A system for estimating a step length in a pedestrian navigation system, comprising:
an acceleration data processing unit calculating a walking frequency and an acceleration variance of a pedestrian by using acceleration data acquired from an acceleration sensor;
a moving distance calculation unit calculating a walking distance of the pedestrian by using GPS data acquired from a GPS receiver; and
a step length estimation unit estimating a step length of the pedestrian by using the calculated walking frequency, acceleration variance, and walking distance.

12. The system of claim 11, wherein the step length estimation unit comprises:
a walking frequency matrix generation unit generating a walking frequency matrix derived from the walking frequency;
an acceleration variance matrix generation unit generating an acceleration variance matrix derived from the acceleration variance; and
a step length estimation coefficient calculation unit calculating step length estimation coefficients of the pedestrian by using the walking frequency matrix and the acceleration variance matrix.

13. The system of claim 11, further comprising a straight walking judgment unit judging whether the pedestrian walks in straight line by using a direction sensor or the GPS data.

14. The system of claim 11, wherein the moving distance calculation unit judges whether the same satellite data set is used to calculate the walking distance by using an NMEA GPGSA message item of the GPS data; and
wherein the NMEA GPGSA message item includes satellite data set information received by the GPS receiver.

15. The system of claim 12, wherein the walking frequency matrix generation unit generates the walking frequency matrix in consideration of inconsistency between a sampling time for acquiring the acceleration data through the acceleration sensor and a sampling time for acquiring the GPS data through the GPS receiver if the sampling times are inconsistent with each other; and
the acceleration variance matrix generation unit generates the acceleration variance matrix in consideration of the inconsistent sampling times.

16. The system of claim 12, wherein the step length estimation coefficient calculation unit calculates the step length estimation coefficients by applying a least square method to the walking frequency matrix and the acceleration variance matrix.
